(19) United States
(12) Patent Application Publication
(10) Pub. No.: US 2002/0060121 A1
(43) Pub. Date: May 23, 2002

(54) Coin distributing device

(76) Inventor: Masaru Igusa, Takasaki-shi (JP)

Correspondence Address: BANNER & WITCOFF, 1001 G STREET N W, SUITE 1100, WASHINGTON, DC, 20001, US

(21) Appl. No.: 09/986,000

(22) Filed: Nov. 7, 2001

(30) Foreign Application Priority Data
Nov. 9, 2000 (JP) 341944/2000

(51) Int. Cl. G07D 7/00

(52) U.S. Cl. 194/302; 453/14; 453/15

(57) ABSTRACT

To provide a coin distributing device capable of increasing a degree of freedom for setting a commodity price because coins of five coin types can be automatically replenished to five coin tubes respectively. In order to attain this object, in the coin distributing device in which, of coins obtained by distributing by means of a distributing unit, specie coins are conducted to various coin tubes or a coin box passage while counterfeit coins are returned to a change outlet, the coin distributing device has five coin tubes so as to cope with five coin types, and each distributing unit is constructed so as to distribute coins to those five coin tubes for each coin type.

### BACKGROUND OF THE INVENTION

1. Field of the Invention

The present invention relates to a coin distributing device, which is a component of a coin mechanism mounted onto a vending machine or the like, and which distributes coins inserted by coin type.

2. Description of the Prior Art

As a device for handling a coin inserted at the time of purchasing a commodity from a vending machine, there is mounted a coin mechanism, and the coin mechanism is provided with a coin distributing device for distributing coins by coin type. Each distributing unit of this coin distributing device is used to distribute coins inserted among counterfeit coins, 50 yen coins, 10 yen coins, 100 yen coins, and 500 yen coins, and specie is received in various coin tubes or a coin box while counterfeit coins are returned to a change outlet. Also, for various coin tubes, there are provided five coin tubes, four tubes of which automatically receive 50 yen coins, 10 yen coins, 100 yen coins and 500 yen coins respectively which have been inserted through a coin insert, and these coins are also used as coins for automatically making change. On the other hand, the remaining one tube is provided as a sub-coin tube, is replenished with 10 yen coins or 100 yen coins in advance, whose change depletion is expected, and the coins which are received in the sub-coin tube are to be used only for making change.

In the above-described prior art coin distributing device, however, since when the sub-coin tube is utilized, an operator must replenish the sub-coin tube with coins by handwork, it is a troublesome operation and the coin distributing device has actually hardly been utilized.

In addition, since the minimum amount of change to be automatically replenished with is 10 yen as described above, commodity prices to be set in the vending machine are set in increments of 10 yen, and the degree of freedom for setting the prices has become small.

### SUMMARY OF THE INVENTION

The present invention has been achieved in views of the above-described conventional problem, and is aimed to provide a coin distributing device in which five coin tubes are individually replenished with five types of coins automatically, these coins automatically replenished can be used as change, and the degree of freedom for setting commodity prices can be increased.

According to a first invention, there is provided a coin distributing device having: a coin identifying unit for identifying types of coins inserted; and a plurality of distributing units for distributing coins identified by the coin identifying unit to each destination, in which, of coins distributed by the distributing units, specie is conducted to various coin tubes or a coin box passage while counterfeit coins are returned to the change outlet, wherein the structure is arranged such that the coin distributing device has five coin tubes so as to correspond to five coin types, and that each distributing unit contributes coins to five coin tubes by coin type.

According to the first invention, since five coin types, for example, 500 yen, 100 yen, 50 yen, 10 yen and 5 yen coins can be received correspondingly to five coin tubes, it is possible to set commodity prices finely.

According to a second invention, there is provided a coin distributing device according to the first invention, wherein the plurality of distributing units have; a first distributing unit for distributing to specie and counterfeit coins; a second distributing unit for distributing specie coins obtained by distributing by the first distributing unit to one coin type group and the other coin type group; a third distributing unit for distributing coins distributed to one coin type group by the second distributing unit to a passage leading to a coin tube in which first coin type coins are received, or a passage leading to each coin tube in which second and third coin type of coins are received; a fourth distributing unit for distributing coins distributed to the other coin type group by the second distributing unit to the coin box passage or a passage leading to each coin tube in which fourth and fifth coin type of coins are received; a fifth distributing unit for distributing coins obtained by distributing by the fourth distributing unit to a passage leading to a coin tube in which fourth coin type of coins are received, or a passage leading to a coin tube in which fifth coin type of coins are received; and a sixth distributing unit for distributing coins obtained by distributing by the third distributing unit to a passage leading to a coin tube in which second coin type of coins are received, or a passage leading to a coin tube in which the third coin type of coins are received.

By means of these first to sixth distributing units, specie coins inserted are distributed to the first coin type (for example, 500 yen), the second coin type (for example, 50 yen), the third coin type (for example, 10 yen), the fourth coin type (for example, 100 yen), and the fifth coin type (for example, 5 yen) respectively, and are received in each coin tube corresponding to each coin type.

According to a third invention, there is provided a coin distributing device according to the second invention, wherein the structure is arranged such that the third distributing unit and the fourth distributing unit are driven by a common solenoid and the fifth distributing unit and the sixth distributing unit are likewise driven by an other common solenoid. According to this third invention, in order to drive the plurality of distributing units by the common solenoid, it is possible to drive a multiplicity of distributing units by means of a small number of driving sources.

In this respect, since by setting the first coin type to 500 yen coin, and the fifth coin type to 5 yen coin, of coins which are generally in circulation, 500 yen, which is the maximum amount, and 5 yen, which is the second minimum amount, can be handled, the use of 500 yen coin can reduce the number of change, and an amount of the rightmost digit of the commodity price can be made into 5 yen through the use of five yen coin. Therefore, the degree of freedom for setting the price becomes large.

The above-described object, any other objects, features and advantages of the present invention will become manifest by the following description and the accompanying drawings.

### BRIEF DESCRIPTION OF THE DRAWINGS

FIG. 1 is an internal constitution view showing a coin identifying unit and a coin distributing unit of a coin mechanism;

FIG. 2 is a perspective view showing a structure of the coin distributing unit and a coin receiving unit of the coin mechanism;

FIGS. 3A and 3B are cross-sectional views showing an operation of a second distributing unit;

FIGS. 4A and 4B are cross-sectional views showing operations of a fifth distributing unit and a sixth distributing unit; and

FIGS. 5A and 5B are explanatory views showing distributing operations of the fifth distributing unit and the sixth distributing unit.

### DESCRIPTION OF THE PREFERRED EMBODIMENTS

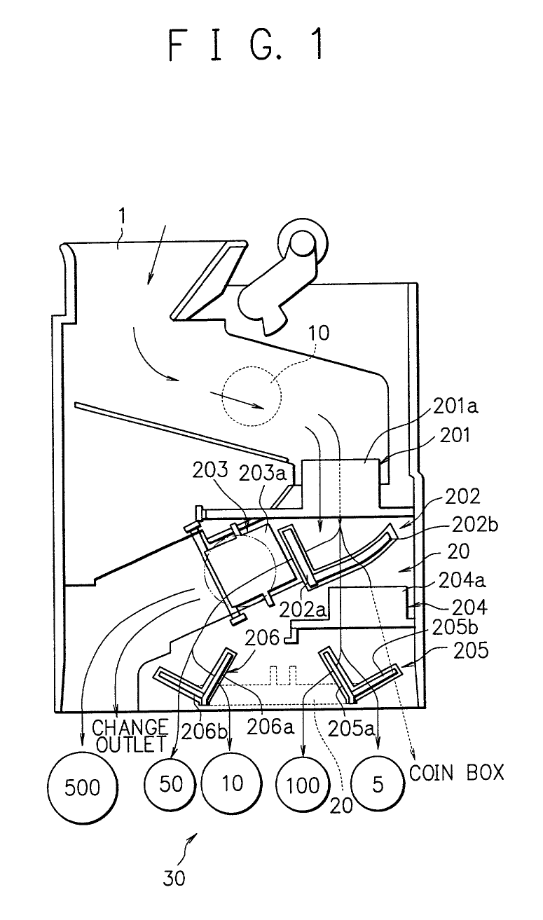

FIGS. 1 to 5A and 5B show a coin distributing device according to an embodiment of the present invention.

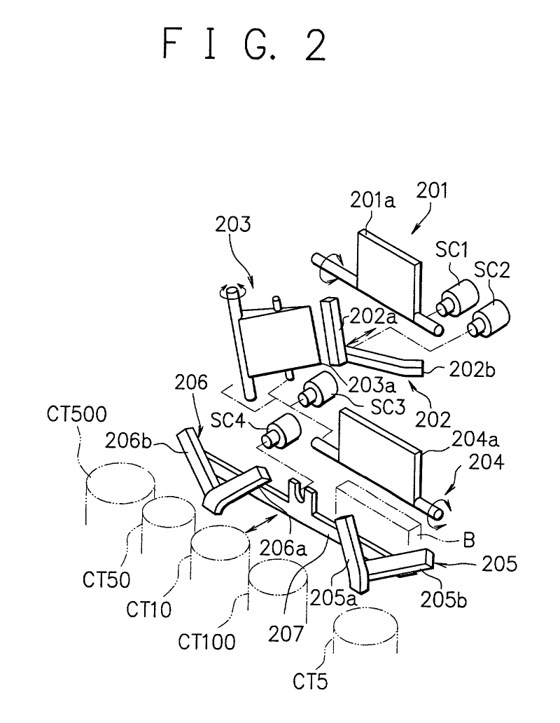

First, with reference to FIGS. 1 and 2, the description will be made of schematic structure of a coin mechanism. The coin mechanism is mounted on, for example, an vending machine, and is composed of: a coin identifying unit 10 for identifying coins (for example, 5 yen coins, 10 yen coins, 50 yen coins, 100 yen coins and 500 yen coins which are Japanese current coins) inserted through a coin insert 1; a coin distributing device 20 for distributing coins obtained by identifying by the coin identifying unit 10; and a coin receiving unit 30 for receiving coins obtained by distributing by the coin distributing device 20, for performing money transactions for purchased commodities.

The coin identifying unit 10 transmits a signal having a predetermined frequency to a coin inserted, identifies on the basis of a change in its received frequency whether the coin inserted is specie or a counterfeit coin, and further when the coin inserted is found to be specie, identifies different types of the 5 yen coin, 10 yen coin, 50 yen coin, 100 yen coin and 500 yen coin.

The coin distributing device 20 is composed of first to sixth distributing units 201 to 206, and the first to sixth distributing units 201 to 206 are installed in order along a coin passage through which the coins inserted pass.

The first distributing unit 201 distributes a coin inserted to a return passage or a second distributing unit 202 on the basis of specie judgment or counterfeit coin judgment of the coin inserted which has been identified by the coin identifying unit 10 as shown in FIGS. 1 and 2. The first distributing unit 201 has a rotating flapper 201a, and this rotating flapper 201a is adapted to rotate by a solenoid SC1. When the solenoid SC1 is in a non-excited state (OFF)(when the coin inserted has been found to be a counterfeit coin), the coin inserted passes through at the front of the rotating flapper 201a, and passes through a return passage (not shown) to be returned to the change outlet. On the other hand, when the solenoid SC1 is in an excited state (ON) (when the coin inserted has been found to be specie), the rotating flapper 201a rotates, and the coin inserted passes on the rear side of the rotating flapper 201a, and falls down toward the second distributing unit 202.

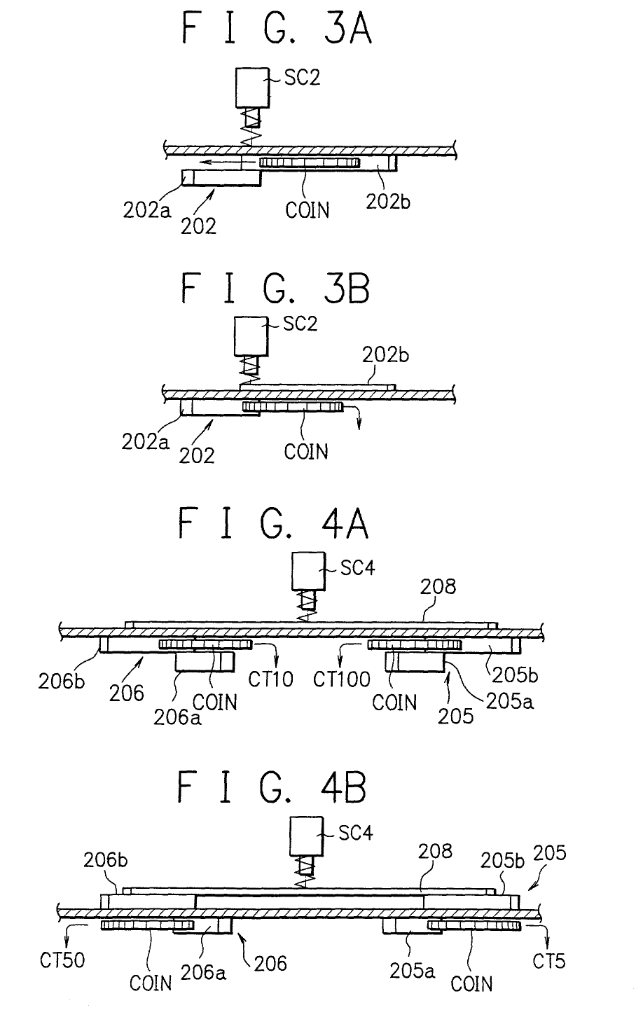

The second distributing unit 202 distributes, as shown also in FIGS. 3A and 3B, coins which have been found to be specie by the first distributing unit 201, to 100 yen coins and 5 yen coins, and 10 yen coins, 50 yen coins and 500 yen coins, which are other than those 100 yen coins and 5 yen coins. The second distributing unit 202 has back-and-forth distributing pieces 202a, 202b which are bifurcated, and these are caused to make frequent appearances from a coin passage A by means of a solenoid SC2. When the solenoid SC2 is in a non-excited state (OFF), the 10 yen coins, 50 yen coins and 500 yen coins are caused to roll to the distributing piece 202b at the rear for being conducted toward the third distributing unit 203 as shown in FIG. 3A. On the other hand, when in an excited state (ON), as shown in FIG. 3B, the second distributing unit 202 is drawn backward to thereby cause the 5 yen coins and 100 yen coins to fall down on the distributing piece 202a at the front for being conducted toward the fourth distributing unit 204.

The third distributing unit 203 has a function to distribute the 10 yen coins, 50 yen coins and 500 yen coins which have been distributed by the second distributing unit 202. The third distributing unit 203 rotates its rotating flapper 203a by means of a solenoid SC3, and when the solenoid SC3 is in an excited state (ON), the rotating flapper 203a is rotated to cause the 10 yen coins and 50 yen coins to fall down toward a sixth distributing unit 206 to be described later. On the other hand, when in a non-excited state (OFF), the 500 yen coins are introduced to the inside thereof for being conducted toward a coin tube CT500 for 500 yen.

The fourth distributing unit 204 has a function to distribute the 100 yen coins and 5 yen coins which have been obtained by distributing by the second distributing unit 202. Also, the fourth distributing unit 204 shares a driving source for its rotating flapper 204a with the solenoid SC3 for the third distributing unit 203. When the solenoid SC3 is in a non-excited state (OFF), the 5 yen coins and 100 yen coins are caused to roll to the surface side of the rotating flapper 204a for being caused to fall down toward the fifth distributing unit 205 to be described later. On the other hand, when the solenoid SC3 is excited (ON), the rotating flapper 204a opens, they are conducted to a coin box passage B (rear side of the rotating flapper 204a) for being introduced into a coin box (not shown). In this respect, when any of various coin tubes CT500, CT100, CT150, CT10 and CT5 is full and corresponds to a coin, whose coins inserted are filled, it is arranged such that the second distributing unit 202 is excited to conduct it to the fourth distributing unit 204, and further the fourth distributing unit 204 is rotated to thereby introduce it into the coin box passage B.

The fifth distributing unit 205 and the sixth distributing unit 206 are controlled by the solenoid SC4, and are integrally formed with a connecting plate 207 connected to this solenoid SC4.

First, with reference to FIGS. 2, 4A and 4B, and 5A and 5B, the description will be made of the fifth distributing unit 205. The fifth distributing unit 205 distributes the 100 yen coins and 5 yen coins, which have been obtained by distributing by the fourth distributing unit 204, to a coin tube CT100 for 100 yen and a coin tube CT5 for 5 yen. The fifth distributing unit 205 has back-and-forth distributing pieces 205a, 205b which are made of resin and are bifurcated, and lower ends of each distributing piece 205a, 205b are fixed to constitute a substantially V-character shape. Also, a coin passage A has a through hole 205c through which each distributing piece 205a, 205b is inserted, and each distributing piece 205a, 205b is adapted to reciprocate back-and-forth through the through hole 205c by means of excitation and non-excitation of the solenoid SC5.

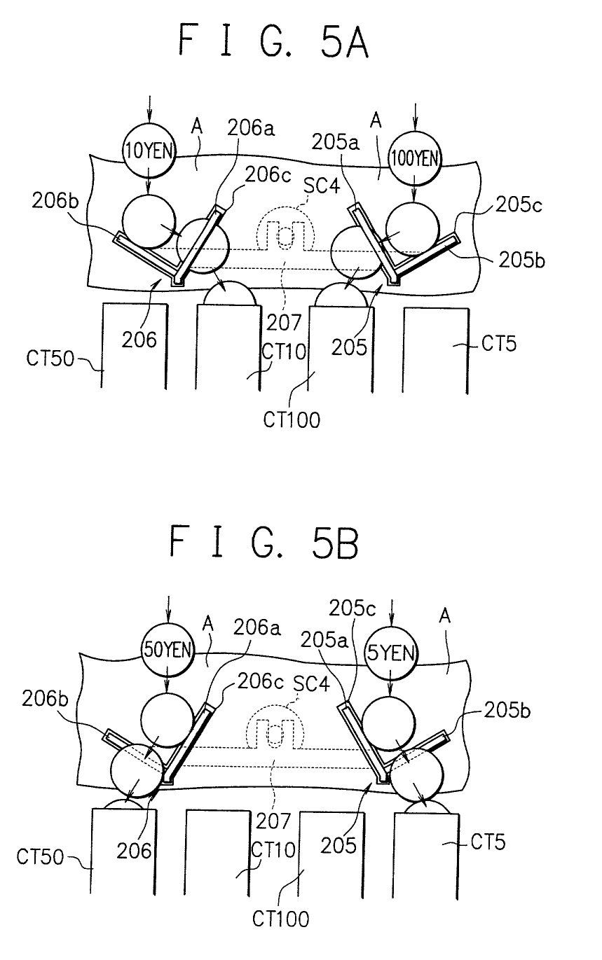

In this case, when it is not excited (OFF), as shown in FIGS. 4A and 5A, the solenoid SC5 causes the 100 yen coins to roll to the rear-side distributing piece 206b for falling down and being received in the coin tube CT100. On the other hand, when in an excited state (ON), as shown in FIGS. 4A and 5B, the connecting plate 207 is drawn backward to thereby cause the 5 yen coins to fall down in the front-side distributing piece 206a for falling down and being received in the coin tube CT5.

The sixth distributing unit 206 distributes the 10 yen and 50 yen coins which have been obtained by distributing by the third distributing unit 203 to the coin tube CT10 for 10 yen and the coin tube CT50 for 50 yen.

This sixth distributing unit 206 has similar structure to the above-described fifth distributing unit 205, and causes back-and-forth distributing pieces 206a, 206b, which are bifurcated, to make frequent appearances from the coin passage A through the through hole 206c. When the solenoid SC4 is not excited (OFF), as shown in FIGS. 4A and 5A, the 10 yen coins are caused to fall on a rear-side distributing piece 206b for falling and being received in a coin tube CT10. On the other hand, when in an excited state (ON), as shown in FIGS. 4B and 5B, the connecting plate 207 is drawn backward to thereby cause the 50 yen coins to fall in the front-side distributing piece 206a for falling down and being received in the coin tube CT50.

According to a coin distributing device structured as described above, it is possible to receive 500 yen, 100 yen, 50 yen, 10 yen and 5 yen coins which correspond to five coin tubes CT500, CT100, CT50, CT10 and CT5 respectively, and to use these coins as a coin for making change, and therefore, the commodity prices can be set in increments of 5 yen, and the degree of freedom for setting the prices can be increased.

Also, since the structure is arranged such that the third distributing unit 203 and the fourth distributing unit 204 are driven by the common solenoid SC3, and the fifth distributing unit 205 and the sixth distributing unit 206 are likewise driven by the solenoid SC4, a driving source for six distributing units 201 to 206 requires four solenoids SC1 to SC4, and the number of the driving sources is small.

In this respect, in the above-described embodiment, the description has been made by using 5 yen coin, 10 yen coin, 50 yen coin, 100 yen coin and 500 yen coin, which are Japanese current coins, as an example, for the coins inserted, but the present invention is likewise applicable even to a coin distributing device for handling current coins in every country, for example, 5 cent coin, 10 cent coin, 25 cent coin, 50 cent coin and 1 dollar coin, which are American current coins.

What is claimed is:

1. A coin distributing device, comprising:
a coin identifying unit for identifying different types of coins inserted; and
a plurality of distributing units for distributing coins identified by said coin identifying unit to each destination,
in which, of coins distributed by each of said distributing units, specie is conducted to various coin tubes or a coin box passage while counterfeit coins are returned to a change outlet,
wherein said coin distributing device has five coin tubes so as to be able to receive five types of coins, and each of said distributing units is constructed such that coins can be distributed to each coin tube applicable to each type.

2. The coin distributing device according to claim 1,
wherein a plurality of distributing units comprise:
a first distributing unit for distributing to specie and counterfeit coins;
a second distributing unit for distributing specie coins obtained by distributing by said first distributing unit to one coin type group and the other coin type group;
a third distributing unit for distributing coins distributed to one coin type group by said second distributing unit to a passage leading to a coin tube in which coins of a first coin type coins are received, or a passage leading to each coin tube in which coins of second and third coin types are received;
a fourth distributing unit for distributing coins distributed to the other coin type group by said second distributing unit to the coin box passage or a passage leading to each of coin tubes in which coins of fourth and fifth coin types are received;
a fifth distributing unit for distributing coins obtained by distributing by said fourth distributing unit to a passage leading to a coin tube in which coins of a fourth coin type are received, or a passage leading to a coin tube in which coins of a fifth coin type are received; and
a sixth distributing unit for distributing coins obtained by distributing by said third distributing unit to a passage leading to a coin tube in which coins of said second coin type are received, or a passage leading to a coin tube in which coins of said third coin type are received.

3. The coin distributing device according to claim 2,
wherein said third distributing unit and said fourth distributing unit can be driven by a common solenoid, and said fifth distributing unit and said sixth distributing unit can be driven by an other common solenoid.

4. The coin distributing device according to claim 2,
wherein a first coin type is, of coins in circulation in an area concerned, set to a coin of the highest amount, and a fifth coin type is set to a coin of the lowest amount of coins in circulation in the area concerned.

5. The coin distributing device according to claim 3,
wherein a first coin type is, of coins in circulation in an area concerned, set to a coin of the highest amount, and a fifth coin type is set to a co in of the lowest amount of coins in circulation in the area concerned.
